(19) United States
(12) Patent Application Publication
(10) Pub. No.: US 2015/0370687 A1
(43) Pub. Date: Dec. 24, 2015

(54) UNIT TEST GENERATION

(71) Applicant: Linkedln Corporation, Mountain View, CA (US)

(72) Inventors: David Stein, Mountain View, CA (US); Parul Jain, Cupertino, CA (US); Lokesh P. Bajaj, Fremont, CA (US)

(21) Appl. No.: 14/309,239

(22) Filed: Jun. 19, 2014

(51) Int. Cl. G06F 11/36; H04L 29/06; H04L 29/08

(52) U.S. Cl. CPC G06F 11/3664; H04L 67/10; H04L 67/42; G06F 11/3684; G06F 11/3688

(57) ABSTRACT

A machine may be configured to generate a unit test based on production data. For example, the machine displays, in an interactive user interface, one or more input-output pairs obtained based on a production log file generated by a production system. Each input-output pair may include an input to a first unit of code executable on the production system and an output that corresponds to the input and that is generated as a result of executing the first unit of code on the production system using the input. The machine may detect a selection of an input-output pair from the one or more input-output pairs displayed in the interactive user interface. The input-output pair may include a particular input and a particular output that corresponds to the particular input. The machine may generate a unit test for testing a second unit of code based on the selected input-output pair.

### TECHNICAL FIELD

The present application relates generally to the processing of data, and, in various example embodiments, to systems and methods for unit test generation.

### BACKGROUND

In computer programming, unit testing is a method by which individual units of source code, sets of one or more computer program modules together with associated control data, usage procedures, and operating procedures are tested to determine if they are fit for use. A unit of code may be viewed as the smallest testable part of an application. In procedural programming, a unit of code is, for example, an individual function or procedure. In object-oriented programming, a unit of code may be an entire interface, such as a class, but could be an individual method. Unit tests may be short code fragments created, in some instances, by programmers during the development process to ensure that the code meets its design and behaves as intended.

### BRIEF DESCRIPTION OF THE DRAWINGS

Some embodiments are illustrated by way of example and not limitation in the figures of the accompanying drawings, in which:

FIG. 1 is a system diagram illustrating a network environment, according to some example embodiments;

FIG. 1A is a system diagram illustrating a network environment, according to some example embodiments;

FIG. 2 is a block diagram illustrating components of a unit test system, according to some example embodiments;

FIGS. 3-11 are flowcharts illustrating a method of generating a unit test, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for generating unit tests for testing units of code based on production data are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Unit testing is a standard practice in the software industry for ensuring software functions as expected. Unit tests are pieces of code whose purpose is to test individual modules (or “units”) of production code or of code undergoing development. When writing unit tests, developers, in some instances, manually construct sample input arguments for the unit of code being tested. In addition, the developers may manually specify the expected output from the unit given the sample input.

Manual construction of sample inputs and expected outputs for unit tests may be an onerous task, especially when the input parameters for the software unit undergoing testing are complicated. The more burdensome it becomes to construct sample inputs, the more expensive it becomes to have thorough unit test coverage, since many units may require multiple unit tests. In some example embodiments, a unit test system eliminates the burden of having to manually specify sample inputs and outputs and, thus, reduces the effort required on the part of the developer to build thorough unit test suites. This, in turn, may make it easier to build and maintain more reliable software.

In some example embodiments, the unit test system generates an interactive user interface (“UI”) that may allow a developer to navigate through real-world sample inputs (e.g., inputs captured at a production system) for the unit that is being tested. The sample inputs, in some instances, may be obtained from a log file of events from a production system (e.g., Kafka tracking data). For purposes of this disclosure, an event is an action or occurrence (e.g., a user's selection of an element of a UI by pressing a button of a computer mouse) detected by a computer program that may be handled by the computer program. In some instances, a user may be the source (or an originator) of the event. In other instances, a hardware device (e.g., a timer) is a source of an event.

Along with each sample input, the developer may be shown in the UI the resulting output obtained by running the sample input through a particular unit of code. When the developer encounters a particular input-output pair that the developer believes represents a good test case, the developer may select an option made available by the UI to save the particular input-output pair for purposes of generating a unit test in a test suite archive file. The developer may also use the UI to search for sample inputs matching certain criteria (e.g. regular expressions), for example, to test edge cases and boundary conditions. As a result, the developer may be able to build a complete unit test suite containing a number of special cases the developer may be concerned about, without manually constructing the inputs and expected outputs for the special cases.

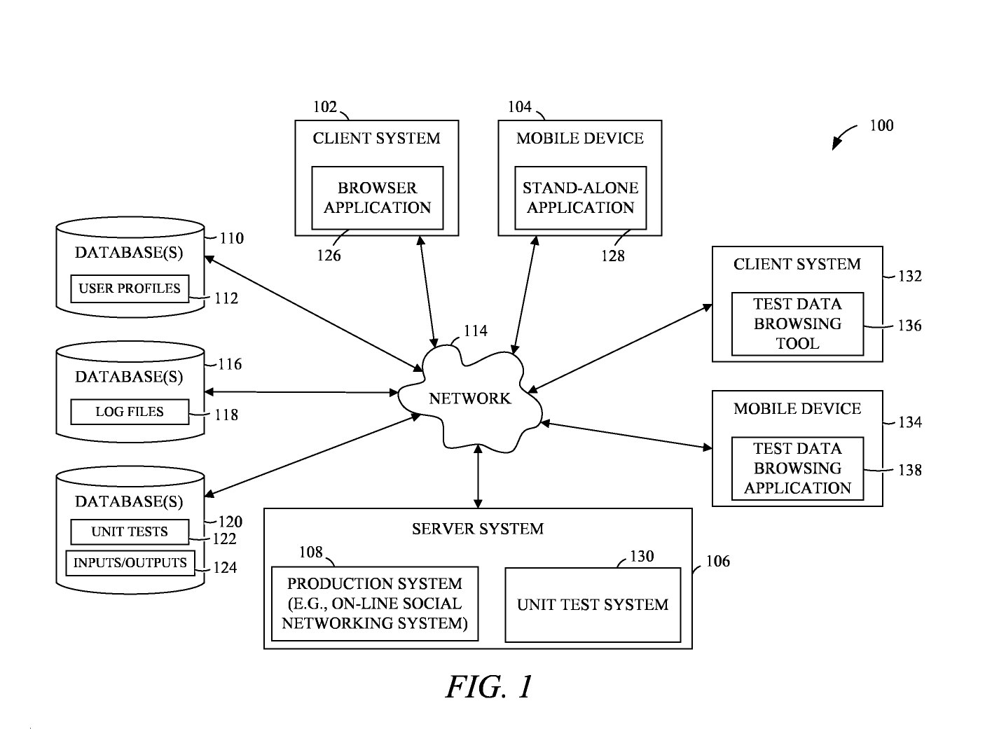

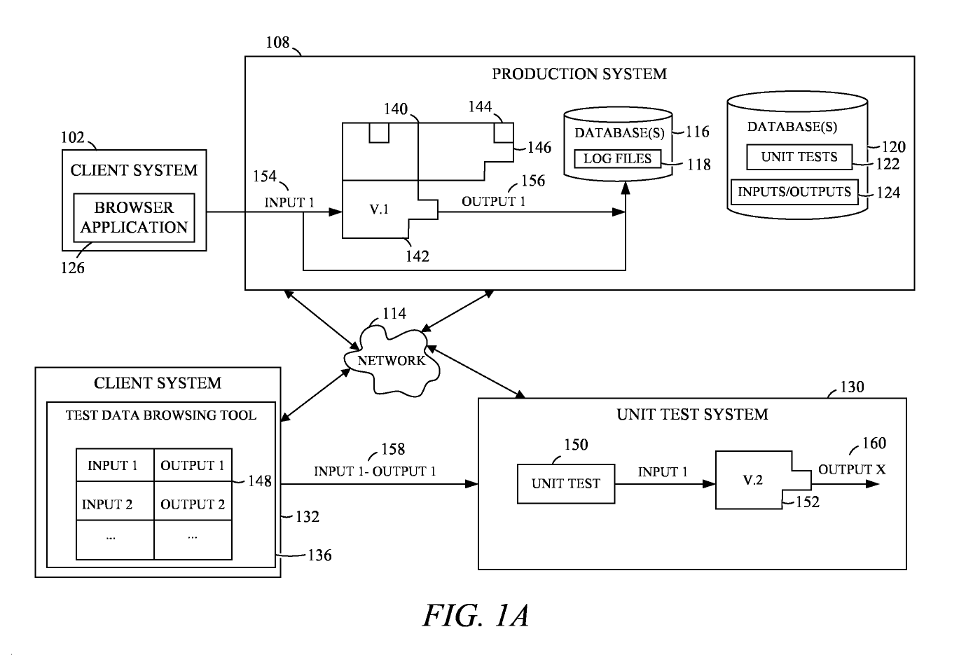

An example method and system for generating a unit test may be implemented in the context of a network environment 100 illustrated in FIG. 1. As shown in FIG. 1, the network environment 100 may include client systems 102 and 104, with client system 104 being a mobile device. The network environment 100 also includes a server system 106. The server system 106 may include one or more computers. In some instances, the server system 106 may be a distributed system. For example, the computers of the server system 106 may be distributed across multiple sites and be interconnected by a communications network. In some example embodiments, the server system 106 may host a production system 108 (e.g., an on-line social network system).

The client system 102 and mobile device 104 may be permitted to access the server system 106 via a communications network 114, utilizing, for example, a browser application 126 executing on the client system 102, or a stand-alone application 128 executing on the mobile device 104. The communications network 114 may be a public network (e.g., the Internet, a mobile communication network, or any other network capable of communicating digital data).

For example, a user (e.g., a member of the on-line social network system) of the client system 102 or of the mobile device 104 using the browser application 126 or the stand-alone application 128, respectively, may access the server system 106 via the communication network 114 and request to view a user profile of a member of the on-line social network system. Each member of the on-line social network may be represented by a member profile that includes personal or professional information about the member, or both. The member profile may be associated with social links that indicate the member's connection to other member profiles in the on-line social network. Member profiles and related information may be stored in a database 110 as user profiles 112.

As shown in FIG. 1, the server system 106 also hosts a unit test system 130. In some example embodiments, the unit test system 130 is not hosted on the server system 106. The unit system 130 may include one or more computers at one site or distributed across multiple sites and interconnected by a communications network.

In certain example embodiments, the unit test system 130 is configured to generate a unit test for testing a unit of code based on certain production data. In some example embodiments, production data may include an input to a first unit of code executable on the production system and an output that corresponds to the input and that is generated as a result of executing the first unit of code on the production system using the input.

In some instances, the input may be indicative of a user's action (e.g., the user clicking a button on the UI in the browser application 126 or the stand-alone application 128) and any additional information related to that action (e.g., the location of the button in the UI) or the user (e.g., a user identifier (ID), whether the user is logged into the client system 102 or the mobile device 104, etc.) The output may be indicative of a result of executing a program (e.g., a unit of code) based on the input received from the user. The input data and the output data for the unit test may be stored as inputs/outputs 124 in the database 120. In some example embodiments, the input data and the output data are stored as input-output groups (e.g., pairs) or as test suites of input-output pairs in the database 120.

As shown in FIG. 1, the network environment 100 may also include client systems 132 and 134, with client system 134 being a mobile device. In some example embodiments, one or both of the client systems 132 and 134 are included in the unit test system 130. In other example embodiments, one or both of the client systems 132 and 134 are not included in the unit test system 130. The client system 132 and mobile device 134 may access the server system 106 via the communications network 114, utilizing, for example, a test data browsing tool 136 executing on the client system 132, or a test data browsing application 138 executing on the mobile device 134. The client system 132, the mobile device 134, the test data browsing tool 136, or the test data browsing application 138, in some instances, may be associated with an engineer (e.g., a software developer or a test engineer) developing a unit test to test a unit of code based on production data (e.g., a particular input-output pair). An example of the unit of code tested using the unit test developed by the engineer is a new version of the production unit of code that received a particular input from the user.

The unit test system 130 may facilitate the selection, for example by the software developer utilizing the client system 132 or the mobile device 134, of a particular input-output pair from one or more input-output pairs displayed by the unit test system 130 in the test data browsing tool 136 or in the test data browsing application, respectively. The particular input-output pair may include data pertaining to a particular event that occurred on a production system, such as the user of client system 102 clicking, via the browser application 126, on a photograph associated with a user profile 112 of a member of the on-line social network hosted on the on-line social networking system 108.

According to some example embodiments, the facilitating of the selection of the particular input-output pair includes detecting a selection of a particular input-output pair from the one or more input-output pairs displayed in an interactive user interface presented to the user of the client system 132 or of the mobile device 134 in the test browsing tool 136 or the test browsing application 138. The unit test system 130 may generate a unit test for testing a unit of code based on certain production data (e.g., one or more input-output pairs). The generated unit tests may be stored as unit tests 122 in the database 140.

FIG. 1A is a system diagram illustrating a network environment, according to some example embodiments. As shown in FIG. 1A, the production system 108 may run a software application 140 that includes one or more software modules (also “units of code”), such as unit 142, unit 144, unit 146, etc. In some instances, one or more of the units 142, 144, and 146 provide a specific functionality of the software application 140. In some instances, the unit 142 is a first version (e.g., v.1) of a particular unit of code.

In some example embodiments, a user of the client system 102, utilizing the browser application 126, interacts (e.g., clicks on a UI element) with the software application 140. As a result of the user interacting with the software application 140, a set of input data (e.g., a first input 154) pertaining to the user interaction is generated (e.g., by the browser application 126). In some instances, the interaction may include the browser application 126 transmitting a command to the unit 142. The command may reference (e.g., include) the first input 154. The production system 108 may execute the unit 142 based on the received first input 154 and may generate a first output 156 as a result of the execution of the unit 142. The first input 154 and the first output 156 may be stored in a production log file 118 of the database 116. The database 116 may or may not be included in the production system 108.

In some example embodiments, the unit test system 130 may access (e.g., retrieve or receive) a production log file 118 and may display the contents of the production log file 118, in an interactive user interface (e.g., generated by the test data browsing tool 136 on the client system 132 or by the test browsing application 138 on the mobile device 134). The production log file may, for example, include one or more inputs and one or more outputs that pertain to one or more interactions by one or more users with the application 140.

In certain example embodiments, the unit test system 130, upon accessing the production log file 118, identifies, in the production log file 118, the first input 154. The first input 154 may be identified, for example, based on an identifier of the first unit of code. The unit test system 130 may also identify, in the production log file 118, the first output 156 that corresponds to the first input 154. A particular output may correspond to a particular input based on the particular output being generated as a result of a unit of code being executed utilizing the particular input. Upon identifying, in the production log file, the first input 154 and the first output 156, the unit test system 130 may generate a first input-output pair that includes the first input 154 and the first output 156. The unit test system 130 may store the first input-output pair as inputs/outputs 124 in the database 120. The database 120 may or may not be included in the production system 108 or in the unit test system 130.

In some example embodiments, the unit test system 130 may display one or more input-output pairs 148 obtained based on the production log file 118, in an interactive user interface (e.g., the test data browsing tool 136 on the client system 132 or the test browsing application 138 on the mobile device 134). Each one or more input-output pairs 148 include an input to a particular unit of code (e.g., the unit 142, the unit 144, or the unit 146) executable on the production system 108 and an output that corresponds to the input and that is generated as a result of executing the particular unit of code on the production system 108 using the input. The input to the different units of code may be the same or different. As shown in FIG. 1A, the test data browsing tool 136 displays one or more input-output pairs (e.g., the plurality of input-output pairs 148), including the first input-output pair comprising the first input 154 and the first output 156.

The user of the client system 132 (e.g., the software developer) may select the first input-output pair from the input-output pairs displayed in the interactive user interface. In some example embodiments, the user's selection of the first input-output pair 158 is communicated by the test data browsing tool 136 to the unit test system 130. In certain example embodiments, the unit test system 130 is configured to detect the selection of the first input-output pair 158 from the one or more input-output pairs displayed in the interactive user interface.

The unit test system 130 may then generate a unit test 150 for testing a second unit of code 152 based on the first input-output pair 158. The first input-output pair includes the first input 154 and the first output 156. The unit test 150 may reference (e.g., include) the first input-output pair 158. The second unit of code 152, in some instances, may be a second version (e.g., v.2) of the first unit of code 142.

The unit test system 130 may test a performance of the second unit of code 152 based on an execution of the unit test 150 using the first input 154 of the first input-output pair 158. The testing of the performance of the second unit of code 152 in some example embodiments includes executing the unit test 150 using the first input 154 of the first input-output pair 158 and generating a further output X 160 based on the execution of the unit test 150 using the first input 154 of the first input-output pair 158. The unit test system 130 may then transmit a communication to the test data browsing tool 136. The communication may include a command to display the first input 154 and the further output X 160 as a further input-output pair in the interactive user interface. The further input-output pair may be displayed in the interactive user interface as part of the input-output pairs 148.

In some example embodiments, the unit test system 130 displays the further output X 160 together with the first output 156 of the first input-output pair 158. The displaying of the further output X 160 together with the first output 156 may facilitate a comparison of the further output X 160 and the first output 156 of the first input-output pair 158.

The user of the client system 132 (e.g., the software developer) may also select, in the interactive user interface, the further input-output pair from the input-output pairs displayed in the interactive user interface. According to some example embodiments, the unit test system 130 detects the further selection of the further input-output pair from the one or more input-output pairs 148 displayed in the interactive user interface. The unit test system 130 may generate a test suite that includes the first input-output pair 158 and the further input-output pair. The unit test system 130 may execute the unit test 150 based on the test suite. The unit test system 130 may store the test suite in the database 120 for use by one or more unit tests 150.

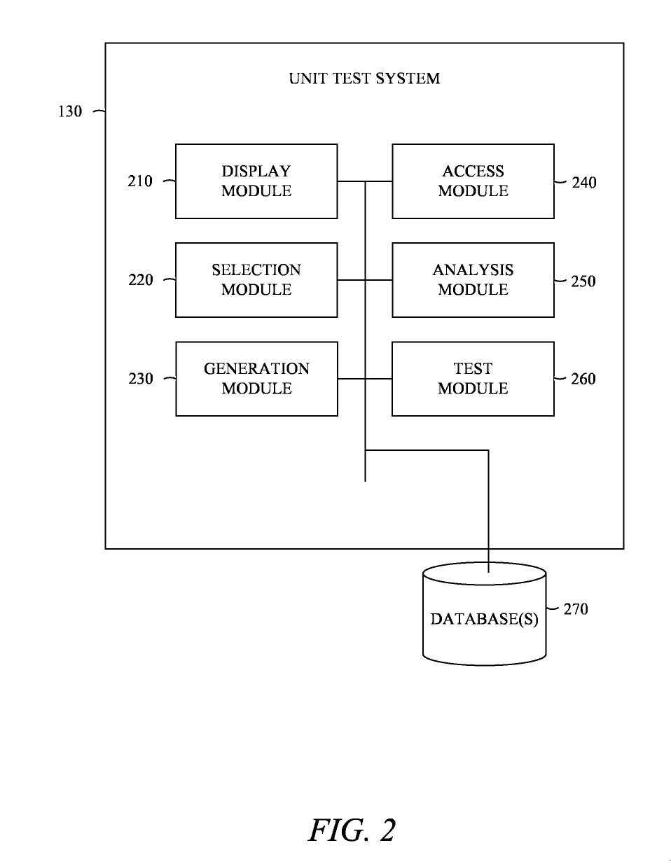

FIG. 2 is a block diagram illustrating components of the unit test system 130, according to some example embodiments. As shown in FIG. 2, the unit test system 130 may include a display module 210, a selection module 220, a generation module 230, an access module 240, an analysis module 250, and a test module 260, all configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 270 (e.g., the database 110, the database 116, or the database 120).

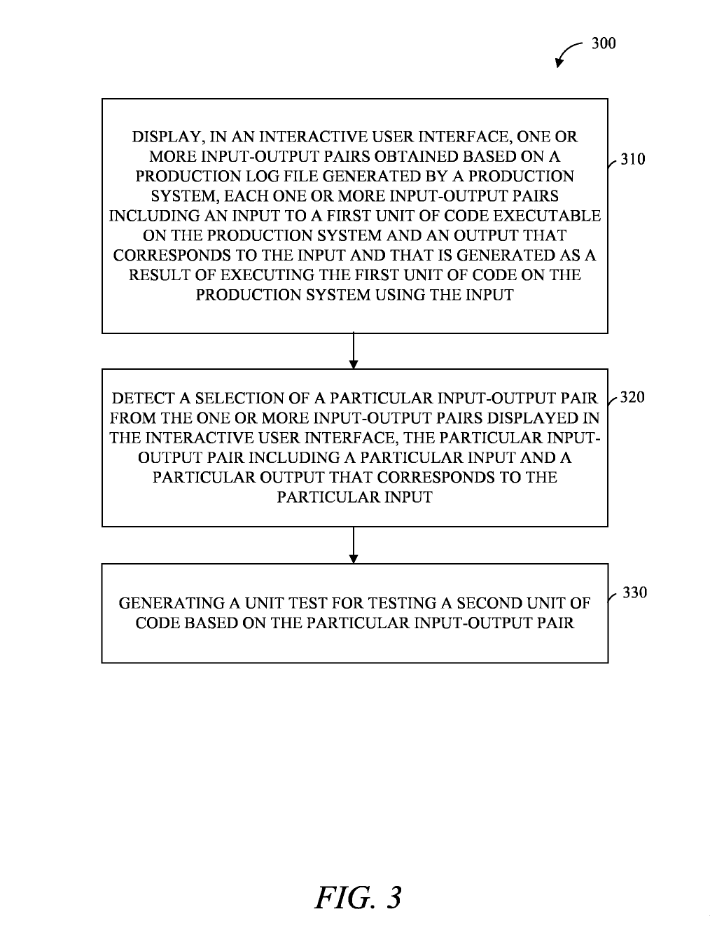

FIGS. 3-11 are flowcharts illustrating a method of generating a unit test, according to some example embodiments. Operations in the method 300 may be performed using modules described above with respect to FIG. 2. As shown in FIG. 3, the method 300 may include one or more of operations 310, 320, and 330.

At method operation 310, the display module 210 displays, in an interactive user interface, one or more input-output pairs. The input-output pairs may be obtained based on a production log file generated by a production system when executing a first unit of code. Each one or more input-output pairs may include an input to the first unit of code executable on the production system and an output that corresponds to the input and that is generated as a result of executing the first unit of code on the production system using the input.

At method operation 320, the selection module 220 detects a selection (e.g., by a user, such as a software developer) of a particular input-output pair from the one or more input-output pairs displayed in the interactive user interface. The particular input-output pair may include a particular input and a particular output that corresponds to the particular input.

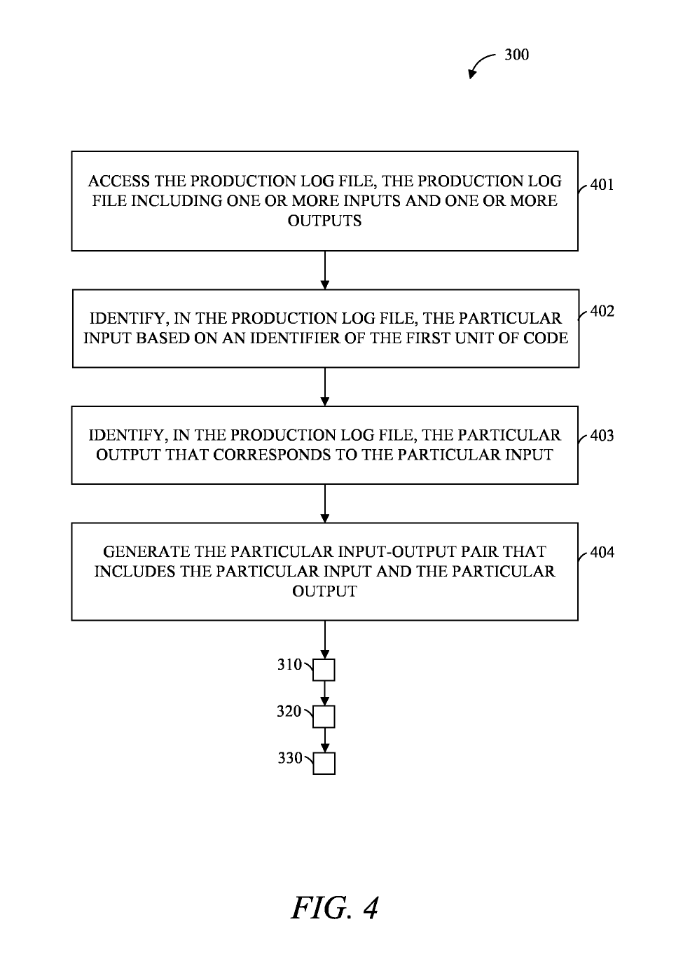

At method operation 330, the generation module 230 generates, using a processor, a unit test for testing a second unit of code based on the particular input-output pair. In some example embodiments, the second unit of code includes a change to the first unit of code. According to some example embodiments, the change to the first unit of code is a new code feature implemented in the second unit of code. In various example embodiments, the second unit of code is a new version of the first unit of code. Further details with respect to the method operations of the method 300 are described below with respect to FIGS. 4-11.

As shown in FIG. 4, the method 300 may include one or more of method operations 401, 402, 403, and 404, according to some example embodiments. Method operation 401 may be performed before method operation 310, in which the display module 210 displays, in an interactive user interface, one or more input-output pairs. At method operation 401, the access module 240 accesses the production log file. The production log file may include one or more inputs and one or more outputs.

Method operation 402 may be performed after method operation 401 and before method operation 310. At method operation 402, the analysis module 250 identifies, in the production log file, the particular input based on an identifier of the first unit of code.

Method operation 403 may be performed after method operation 402 and before method operation 310. At method operation 403, the analysis module 250 identifies, in the production log file, the particular output that corresponds to the particular input.

Method operation 404 may be performed after method operation 403 and before method operation 310. At method operation 404, the analysis module 250 generates the particular input-output pair that includes the particular input and the particular output.

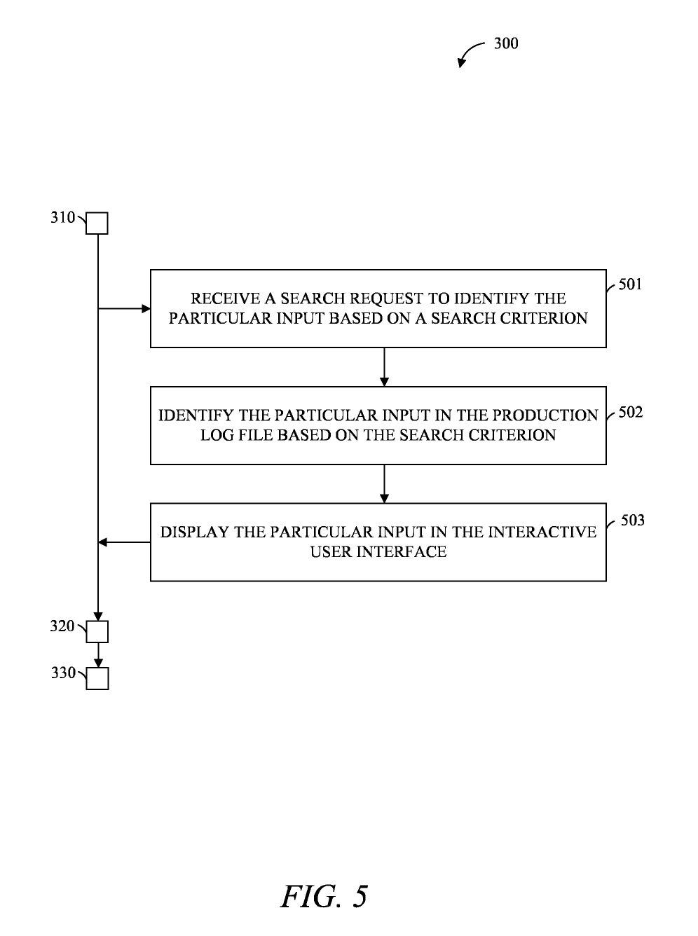

As shown in FIG. 5, the method 300 may include one or more of method operations 501, 502, and 503, according to some example embodiments. Method operation 501 may be performed after method operation 310, in which the display module 210 displays, in an interactive user interface, one or more input-output pairs, and before method operation 320, in which the selection module 220 detects a selection of a particular input-output pair from the one or more input-output pairs displayed in the interactive user interface. At method operation 501, the analysis module 250 receives a search request to identify the particular input based on a search criterion. An example of a search criterion is a regular expression.

Method operation 502 may be performed after method operation 501. At method operation 502, the analysis module 250 identifies the particular input in the production log file based on the search criterion.

Method operation 503 may be performed after method operation 502. At method operation 503, the display module 210 displays the particular input in the interactive user interface.

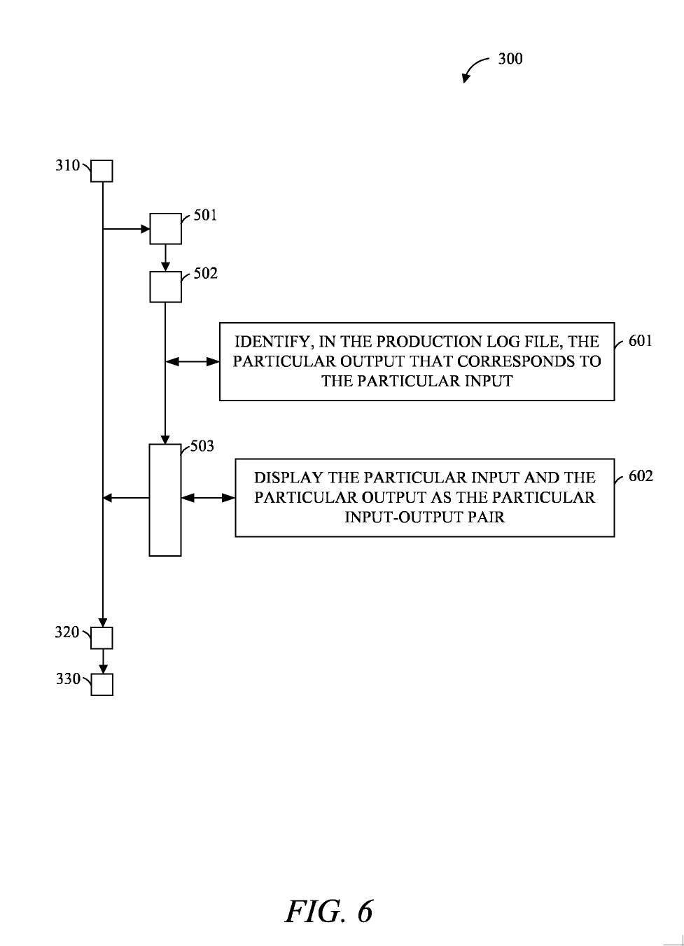

As shown in FIG. 6, the method 300 may include one or more of method operations 601 and 602, according to some example embodiments. Method operation 601 may be performed after method operation 502, in which the analysis module 250 identifies the particular input in the production log file based on the search criterion, and before method operation 503, in which the display module 210 displays the particular input in the interactive user interface. At method operation 601, the analysis module 250 identifies, in the production log file, the particular output that corresponds to the particular input.

Method operation 602 may be performed as part (a precursor task, a subroutine, or a portion) of method operation 503, in which the display module 210 displays the particular input in the interactive user interface. At method operation 602, the display module 210 displays the particular input and the particular output together as the particular input-output pair.

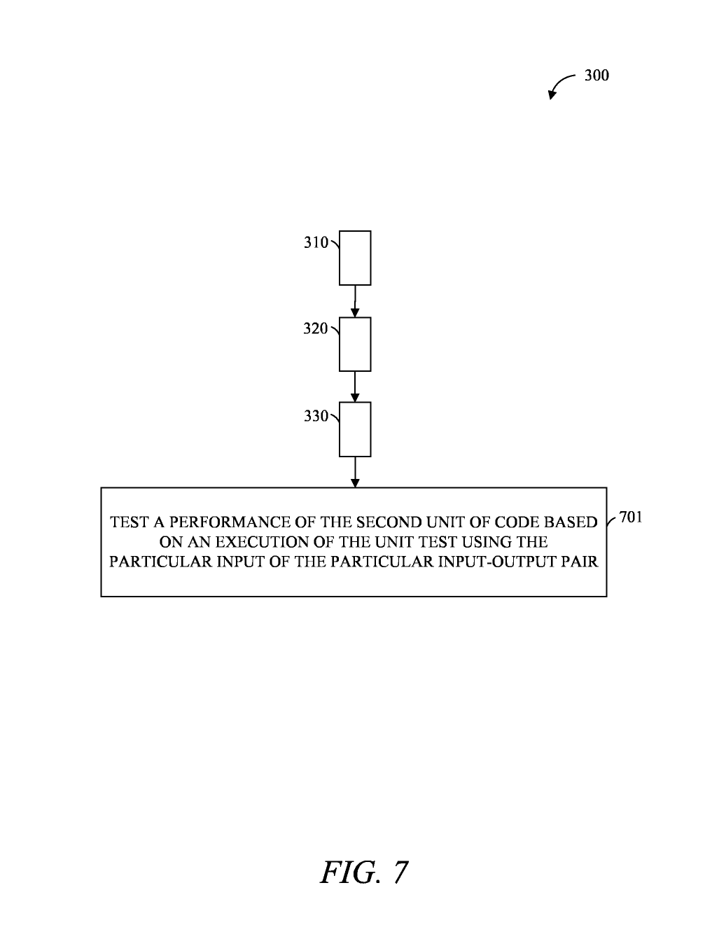

As shown in FIG. 7, the method 300 may include method operation 701, according to some example embodiments. Method operation 701 may be performed after method operation 330, in which the generation module 230 generates a unit test for testing a second unit of code based on the particular input-Attorney output pair. At method operation 701, the test module 260 tests a performance of the second unit of code based on an execution of the unit test using the particular input of the particular input-output pair.

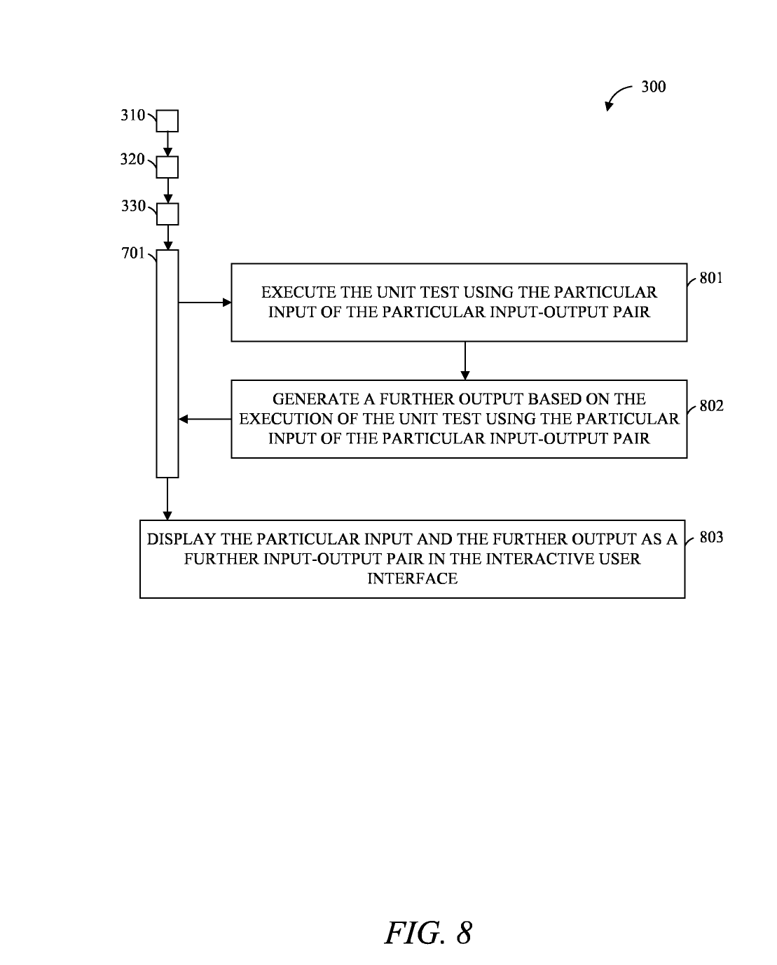

As shown in FIG. 8, the method 300 may include one or more method operations 801, 802, and 803, according to some example embodiments. Method operation 801 may be performed as part (a precursor task, a subroutine, or a portion) of method operation 701, in which the test module 260 tests a performance of the second unit of code based on an execution of the unit test using the particular input of the particular input-output pair. At method operation 801, the test module 260 executes the unit test using the particular input of the particular input-output pair.

Method operation 802 may be performed as part (a precursor task, a subroutine, or a portion) of method operation 701 after method operation 801. At method operation 802, the test module 260 generates a further output based on the execution of the unit test using the particular input of the particular input-output pair.

Method operation 803 may be performed after method operation 701, in which the test module 260 tests a performance of the second unit of code based on an execution of the unit test using the particular input of the particular input-output pair. At method operation 803, the display module displays the particular input and the further output as a further input-output pair in the interactive user interface.

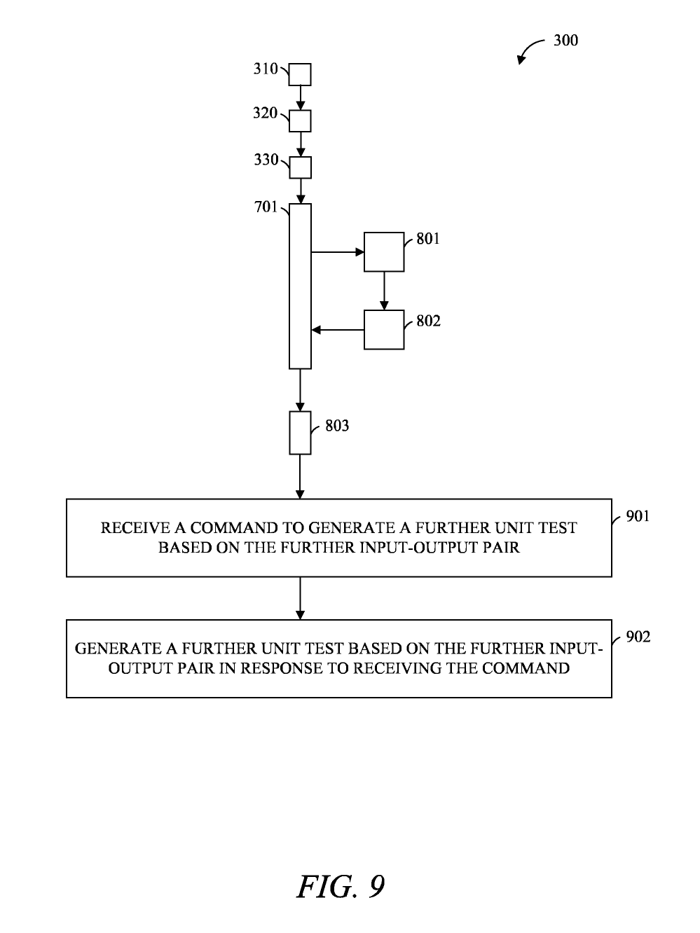

As shown in FIG. 9, the method 300 may include one or more method operations 901 and 902, according to some example embodiments. Method operation 901 may be performed after method operation 803, in which the display module displays the particular input and the further output as a further input-output pair in the interactive user interface. At method operation 901, the generation module 230 receives a command to generate a further unit test based on the further input-output pair. The command may be received from a user (e.g., a software developer) via the client system 132 or the mobile device 134. For example, the selection by the software developer of a particular element (e.g., a button) of an interactive user interface (e.g., the test data browsing tool 136) may result in the issuance of a command to generate a further unit test based on the further input-output pair.

Method operation 902 may be performed after method operation 901. At method operation 902, the generation module 230 generates a further unit test based on the further input-output pair in response to receiving the command. The further unit test may be stored in a record of a database (e.g., the database 120).

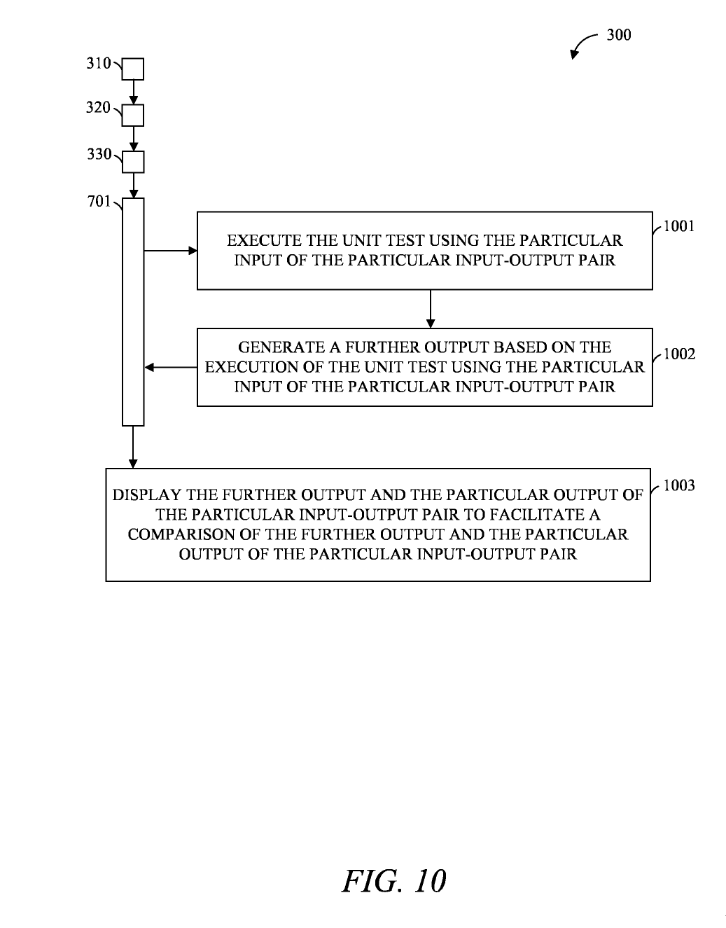

As shown in FIG. 10, the method 300 may include one or more method operations 1001, 1002, and 1003, according to some example embodiments. Method operation 1001 may be performed as part (a precursor task, a subroutine, or a portion) of method operation 701, in which the test module 260 tests a performance of the second unit of code based on an execution of the unit test using the particular input of the particular input-output pair. At method operation 1001, the test module 260 executes the unit test using the particular input of the particular input-output pair.

Method operation 1002 may be performed as part (a precursor task, a subroutine, or a portion) of method operation 701 after method operation 1001. At method operation 1002, the test module 160 generates a further output based on the execution of the unit test using the particular input of the particular input-output pair.

Method operation 1003 may be performed after method operation 701, in which the test module 260 tests a performance of the second unit of code based on an execution of the unit test using the particular input of the particular input-output pair. At method operation 1003, the display module displays the further output and the particular output of the particular input-output pair to facilitate a comparison (e.g., by the software developer) of the further output and the particular output of the particular input-output pair.

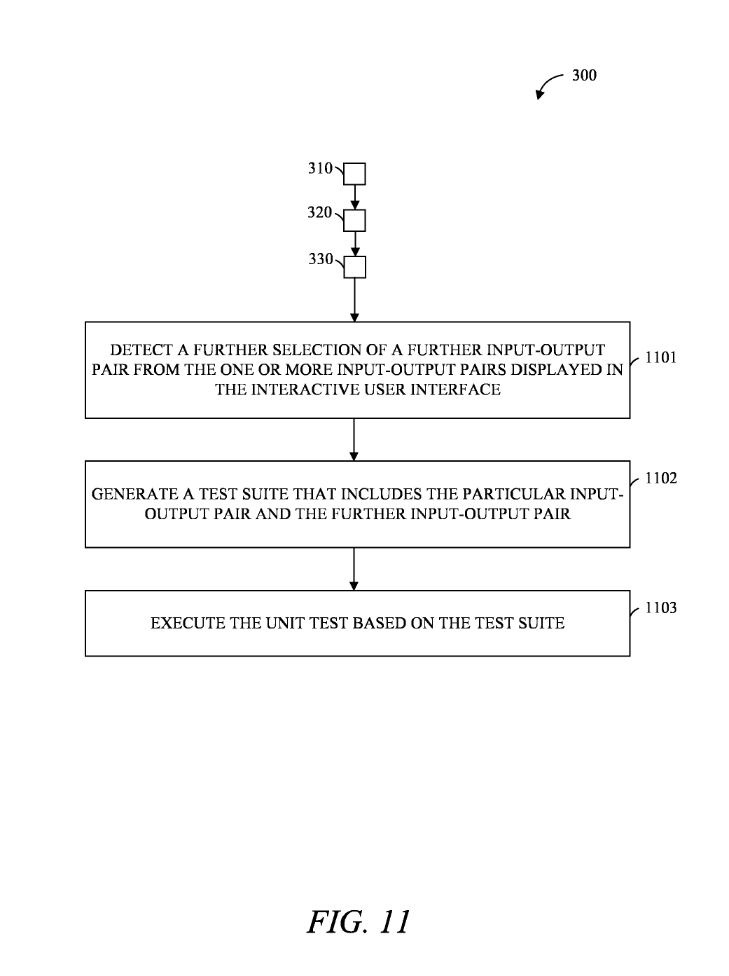

As shown in FIG. 11, the method 300 may include one or more method operations 1101, 1102, and 1103, according to some example embodiments. Method operation 1101 may be performed after method operation 330, in which the generation module 230 generates a unit test for testing a second unit of code based on the particular input-output pair. At method operation 1101, the selection module 220 detects a further selection (e.g., by a user, such as a software developer) of a further input-output pair from the one or more input-output pairs displayed in the interactive user interface.

Method operation 1102 may be performed after method operation 1101. At method operation 1102, the generation module 230 generates a test suite that includes the particular input-output pair and the further input-output pair.

Method operation 1103 may be performed after method operation 1102. At method operation 1103, the test module 260 executes the unit test based on the test suite.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

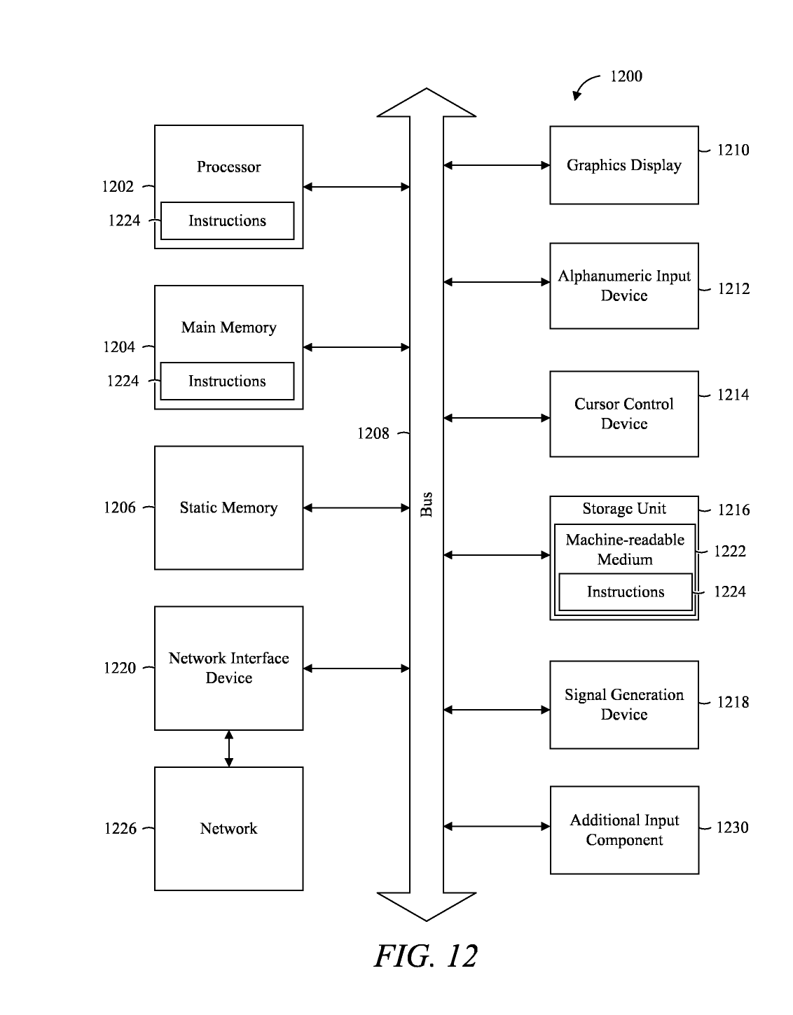

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
displaying, in an interactive user interface, one or more input-output pairs obtained based on a production log file generated by a production system, each of the one or more input-output pairs including an input to a first unit of code executable on the production system and an output that corresponds to the input and that is generated as a result of executing the first unit of code on the production system using the input, the input being captured at the production system;
detecting a selection of a particular input-output pair from the one or more input-output pairs displayed in the interactive user interface, the particular input-output pair including a particular input and a particular output that corresponds to the particular input; and
generating, using a processor, a unit test for testing a second unit of code based on the particular input-output pair.

2. The method of claim 1, further comprising:
accessing the production log file, the production log file including one or more inputs and one or more outputs that correspond to the one or more inputs;
identifying, in the production log file, the particular input based on an identifier of the first unit of code;
identifying, in the production log file, the particular output that corresponds to the particular input; and
generating the particular input-output pair that includes the particular input and the particular output.

3. The method of claim 1, further comprising:
receiving a search request to identify the particular input based on a search criterion;
identifying the particular input in the production log file based on the search criterion; and
displaying the particular input in the interactive user interface.

4. The method of claim 1, further comprising identifying, in the production log file, the particular output that corresponds to the particular input, and wherein
the particular input is displayed together with the particular output as the particular input-output pair.

5. The method of claim 1, further comprising testing a performance of the second unit of code based on an execution of the unit test using the particular input of the particular input-output pair.

6. The method of claim 5, wherein the testing the performance of the second unit of code includes:
executing the unit test using the particular input of the particular input-output pair and
generating a further output based on the execution of the unit test using the particular input of the particular input-output pair; and further comprising
displaying the particular input and the further output as a further input-output pair in the interactive user interface.

7. The method of claim 6, further comprising:
receiving a command to generate a further unit test based on the further input-output pair; and
generating a further unit test based on the further input-output pair in response to receiving the command.

8. The method of claim 5, wherein the testing the performance of the second unit of code includes:
executing the unit test using the particular input of the particular input-output pair and
generating a further output based on the execution of the unit test using the particular input of the particular input-output pair; and further comprising
displaying the further output and the particular output of the particular input-output pair to facilitate a comparison of the further output and the particular output of the particular input-output pair.

9. The method of claim 1, wherein the second unit of code includes a change to the first unit of code.

10. The method of claim 9, wherein the change is a new code feature implemented in the second unit of code.

11. The method of claim 1, further comprising:
detecting a further selection of a further input-output pair from the one or more input-output pairs displayed in the interactive user interface;
generating a test suite that includes the particular input-output pair and the further input-output pair; and
executing the unit test based on the test suite.

12. A system comprising:
a machine-readable medium for storing instructions that, when executed by the one or more hardware processors of a machine, cause the machine to perform operations comprising:
displaying, in an interactive user interface, one or more input-output pairs obtained based on a production log file generated by a production system, each of the one or more input-output pairs including an input to a first unit of code executable on the production system and an output that corresponds to the input and that is generated as a result of executing the first unit of code on the production system using the input, the input being captured at the production system;
detecting a selection of a particular input-output pair from the one or more input-output pairs displayed in the interactive user interface, the particular input-output pair including a particular input and a particular output that corresponds to the particular input; and
generating a unit test for testing a second unit of code based on the particular input-output pair.

13. The system of claim 12, wherein the operations further comprise:
accessing the production log file, the production log file including one or more inputs and one or more outputs;
identifying, in the production log file, the particular input based on an identifier of the first unit of code;
identifying, in the production log file, the particular output that corresponds to the particular input; and
generating the particular input-output pair that includes the particular input and the particular output.

14. The system of claim 12, wherein the operations further comprise:
receiving a search request to identify the particular input based on a search criterion;
identifying the particular input in the production log file based on the search criterion; and
displaying the particular input in the interactive user interface.

15. The system of claim 12, wherein the operations further comprise:
testing a performance of the second unit of code based on an execution of the unit test using the particular input of the particular input-output pair.

16. The system of claim 15, wherein the testing of the performance of the second unit of code includes:
executing the unit test using the particular input of the particular input-output pair and
generating a further output based on the execution of the unit test using the particular input of the particular input-output pair, and wherein the operations further comprise:
displaying the particular input and the further output as a further input-output pair in the interactive user interface.

17. The system of claim 16, wherein the operations further comprise:
receiving a command to generate a further unit test based on the further input-output pair, and
generating a further unit test based on the further input-output pair in response to receiving the command.

18. The system of claim 15, wherein the testing the performance of the second unit of code includes:
executing the unit test using the particular input of the particular input-output pair and
generating a further output based on the execution of the unit test using the particular input of the particular input-output pair, and wherein the operations further comprise:
displaying the further output and the particular output of the particular input-output pair to facilitate a comparison of the further output and the particular output of the particular input-output pair.

19. The system of claim 12, wherein the operations further comprise:
detecting a further selection of a further input-output pair from the one or more input-output pairs displayed in the interactive user interface;
generating a test suite that includes the particular input-output pair and the further input-output pair; and
executing the unit test based on the test suite.

20. A non-transitory machine-readable storage medium comprising instructions that, when executed by one or more hardware processors of a machine, cause the machine to perform operations comprising:
displaying, in an interactive user interface, one or more input-output pairs obtained based on a production log file generated by a production system, each of the one or more input-output pairs including an input to a first unit of code executable on the production system and an output that corresponds to the input and that is generated as a result of executing the first unit of code on the production system using the input, the input being captured at the production system;
detecting a selection of a particular input-output pair from the one or more input-output pairs displayed in the interactive user interface, the particular input-output pair including a particular input and a particular output that corresponds to the particular input; and
generating a unit test for testing a second unit of code based on the particular input-output pair.
